(19) United States
(12) Patent Application Publication
(10) Pub. No.: US 2008/0247308 A1
(43) Pub. Date: Oct. 9, 2008

(54) PROVIDING SESSION REDUNDANCY USING PRIORITY DURING A SYNCING PROCESS

(75) Inventors: Bhaskar Bhupalam, Sunnyvale, CA (US); Anand K. Oswal, Sunnyvale, CA (US); Jayaraman Iyer, Sunnyvale, CA (US); Michael Shannon, San Jose, CA (US)

Correspondence Address: Trellis Intellectual Property Law Group, PC, 1900 EMBARCADERO ROAD, SUITE 109, PALO ALTO, CA, 94303, US

(73) Assignee: CISCO TECHNOLOGY, INC., San Jose, CA (US)

(21) Appl. No.: 11/696,548

(22) Filed: Apr. 4, 2007

(51) Int. Cl. H04J 3/14

(52) U.S. Cl. 370/217; 370/503

(57) ABSTRACT

In one embodiment, sessions are synced from an active device to a standby device according to a priority. One or more attributes are determined for a plurality of sessions that need to be synced between an active device and a standby device. The attributes may be used to determine a value of syncing a session. A priority for syncing the sessions based on the attributes is then determined. The sessions are then synced based on the priority. For example, a portion of sessions considered to be of a higher priority may be synced before a portion of sessions considered to be of a lower priority. Because the sessions considered of a higher priority are synced first, if a double failure occurs where the active device fails during the syncing process, at least the higher priority sessions have been synced with the standby device and the standby device can take over these sessions.

### TECHNICAL FIELD

Particular embodiments generally relate to redundancy in networks.

### BACKGROUND

Stateful redundancy is a requirement for service providers to achieve higher customer satisfaction. Stateful redundancy implies that more than one copy of session state is maintained such that currently connected sessions will continue to receive the same service even during a failure of an active entity. For example, a user participating in a voice call would continue to receive the same uninterrupted service if an active gateway handling the call fails. In this case, a standby gateway may have the same session information and may be able to continue the voice call.

There are times when a bulk sync of active sessions needs to occur, such as when a standby device reboots or fails. The active device will provide all the session information in a bulk sync. During the bulk sync period, the standby brings up sessions as it receives information for the sessions, but does not mark itself as ready to take over any of the sessions until all of the sessions of the bulk sync are brought up. The bulk sync period is not a simple memory copy and bringing up the sessions such that the standby can be ready to take over may be a long process that may be in the order of minutes. This process may be compounded when more than one active device is syncing with the standby device.

If an active device fails during a bulk sync and the standby has not finished receiving all the session sync information, the standby device may not be ready to instantly take over for the active device because it is not ready. Also, even if the standby can take over the sessions, it can only take over for the sessions in which the session information has been received. Typically, the oldest sessions are synced first and then the newer sessions. The users whose session information was not synced may lose service. This may result in disruption of service for users that may be considered more valuable than the users that were already synced. Losing sessions for more valuable customers may be undesirable for a service provider.

### BRIEF DESCRIPTION OF THE DRAWINGS

FIG. 1 depicts an example of a system for syncing sessions.

FIG. 2 depicts a more detailed example of an active device and a standby device.

FIG. 3 depicts a simplified method for performing a syncing of sessions.

FIG. 4 depicts a more detailed example of a method for syncing sessions.

### DESCRIPTION OF EXAMPLE EMBODIMENTS

### Overview

In one embodiment, sessions are synced from an active device to a standby device according to a priority. One or more attributes are determined for a plurality of sessions that need to be synced between an active device and a standby device. A priority for syncing the sessions based on the attributes is then determined. The sessions are then synced based on the priority. For example, a portion of sessions considered to be of a higher priority may be synced before a portion of sessions considered to be of a lower priority. Because the sessions considered of a higher priority are synced first, if a double failure occurs where the active device fails during the syncing process, at least the higher priority sessions have been synced with the standby device and the standby device can take over these sessions.

### Example Embodiments

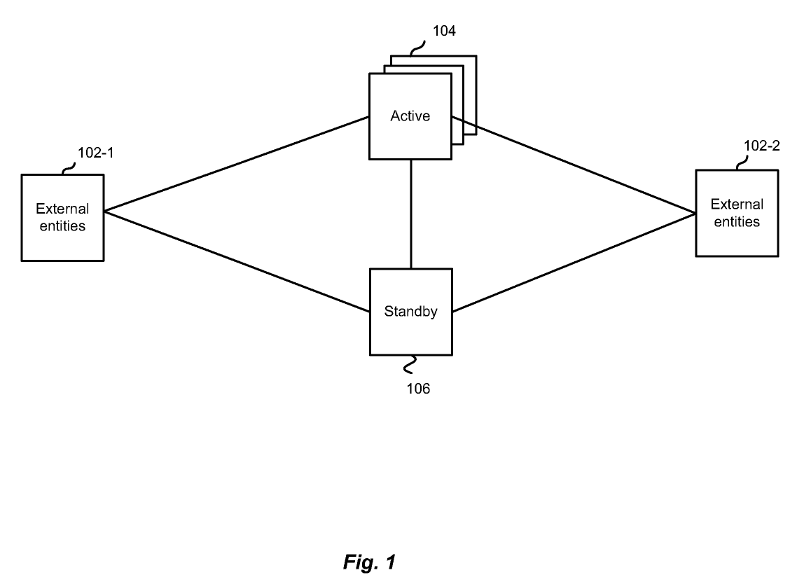

FIG. 1 depicts an example of a system for syncing sessions. As shown, external entities 102, active devices 104, and a standby device 106 are provided. Although a single instance of components in the system are shown, it will be understood that any number may be provided. For example, any number of active devices 104 may be syncing with a standby device 106. Further, any number of external entities 102 may be participating in sessions with active devices 104.

Active device 104 may be any device that may be handling sessions with external entity 102-1. For example, active device 104 may be a router, gateway, DSL router, mobile wireless gateway, etc.

External entities 102 may be any devices that are a participant in a session with active device 104. For example, voice sessions, data sessions, etc. may be created with active device 104.

Standby device 106 is configured to store redundant data for sessions in active device 104. If active device 104 fails, then standby device 106 can start servicing the sessions for active device 104. Standby device 106 may be router, gateway, DSL router, mobile wireless gateway, etc.

Standby device 106 stores redundant data for sessions on active device 104. A session may be any connection in which data is being transferred. For example, a session may be a voice call, data connection, etc. The redundant data may include any information for a session that is needed to service the session, such as user information for the session, contact information for the entities, etc.

While being ready to take over sessions, standby device 106 may service sessions in a normal operation. For example, as sessions are brought up on active device 104, they may be synced with standby device 106. When standby device 106 has brought up the session (i.e., standby device 106 is available to take over the session if a failure results), standby device 106 sends an indication to active device 104. Also, additional information for current sessions may need to be synced with standby device 106 when necessary. However, there may be times when a bulk sync of multiple sessions needs to be performed. For example, standby device 106 may fail and reboot; thus causing standby device 106 to lose all the session information that was synced. Accordingly, all the session information needs to be re-synced from active device 104 to standby device 106.

When a bulk sync occurs, particular embodiments determine a priority for syncing the sessions. For example, sessions that are considered of a higher priority or more important may be synced first with standby device 106. Standby device 106 brings up the higher priority sessions and can then send an indication to active device 104 that they have been brought up. Standby device 106 may mark itself as ready to service these sessions. Active device 104 may also send session information for the lower priority sessions after sending the higher priority sessions. After these higher priority sessions have been synced, sessions that were considered a lower priority are then synced.

Accordingly, higher priority sessions are synced first. Thus, if any failure occurs, such as active device 104 fails before all the sessions have been synced, it is possible that standby device 106 can take over and service the higher priority sessions. This provides better customer service for users that may be considered a higher priority.

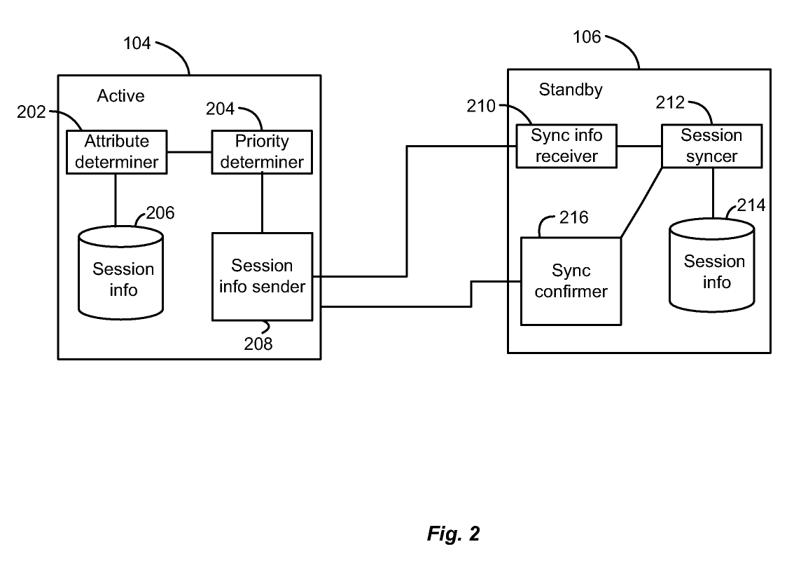

FIG. 2 depicts a more detailed example of active device 104 and standby device 106. An attribute determiner 202 is configured to determine attributes for sessions. Attribute determiner 202 may determine the attribute information based on session information in storage 206.

In one embodiment, the attributes may include information about a session, such as a session service level (QoS), a session status, a session type, user information, etc. The session service level may include different levels of service that are promised, such as a premium or standard level. The session status may include whether a session is an active session, an idle session, a dormant session, etc. The session type may include the session set-up time required for a session on standby. The user information may be any information for a user of external entities 102.

A priority determiner 204 then determines a priority for syncing sessions based on the one or more attributes determined. For example, sessions that are considered more important may be given a higher priority than sessions that are considered of lower importance. In one embodiment, priority determiner 204 may determine an order for the sessions that need to be synced. The order may be a ranking of sessions from the most important to the least important. Also, the order may be a grouping such as sessions that are grouped into a first portion of higher priority sessions and a second portion of lower priority sessions. It may be understood that any number of portions or groups may be determined.

Session information sender 208 then syncs the sessions with standby device 106. In one embodiment, the first portion of sessions that are considered of a higher priority may be synced first. Thus, session information sender 208 sends the session information for all of these sessions. In one embodiment, session information sender 208 may send an indication that all the higher priority sessions have been sent and the lower priority sessions are now being sent. In other embodiments, session information sender 208 may stop sending information until the higher priority sessions have been successfully brought up by standby device 106. This may ensure that standby device 106 is not overloaded.

At standby device 106, a sync information receiver 210 receives the session information. Sync information receiver 210 may buffer this information depending on the processing load of standby device 106 and how much information it can process in bringing up sessions.

A session syncer 212 brings up the sessions. The session information may be stored in storage 214 and any other actions that are needed to bring the sessions into a state where standby device 106 can take over the sessions is performed.

A sync conformer 216 may then send a message to active device 104 that the portion of sessions has been synced and it is ready to take over the sessions. For example, standby device 102 may mark itself as being ready to take over the synced portion of sessions (e.g. the higher priority sessions). Before standby device 102 is marked as ready, it may devote substantially all its resources to bringing up sessions. However, when it is ready to take over sessions, additional tasks may have to be performed. For example, the sessions that have been synced have to be serviced, such as data from external entities may be received at active device 104 and synced with standby device 102 during the session. Also, new sessions may have to be synced with standby device 102 as they are created. Thus, fewer resources can be devoted to bringing up sessions. However, because standby device 102 is ready to take over sessions, if a failure occurs, it can take over. If standby device 102 was not marked as ready, then it may or may not be able to take over the sessions.

After sending the first portion of sessions, active device 104 then determines a second portion of sessions to sync. These sessions may be considered of a lower importance from the first portion of sessions. The processing continues as session information for these sessions is sent to standby device 106. Standby device 106 may then bring up the sessions in the background as it is focusing resources on other tasks that are required. Thus, standby device 106 focuses on bringing up the sessions that are considered of a higher priority first. Then, standby device 106 marks itself as being ready. The rest of the sessions may then be brought up in a background mode.

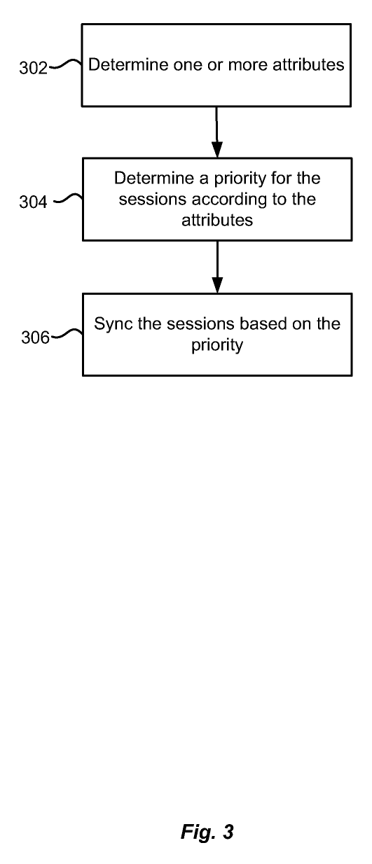

FIG. 3 depicts a simplified method for performing a syncing of sessions. Step 302 determines one or more attributes. The one or more attributes may be for sessions that are being serviced in active device 104.

Step 304 determines a priority for the sessions according to the attributes. The priority may order the sessions in an order of importance.

Step 306 syncs the sessions based on the priority. For example, a first portion of a session that may be considered of a higher priority may be synced first.

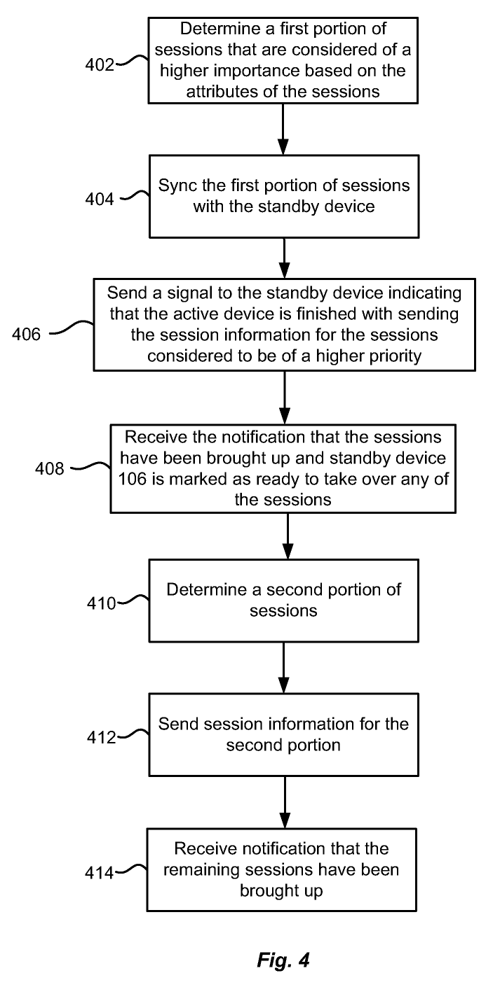

FIG. 4 depicts a more detailed example of a method for syncing sessions. Step 402 determines a first portion of sessions that are considered of a higher importance based on the attributes of the sessions.

Step 404 then syncs the first portion of sessions with standby device 106. For example, active device 106 sends the necessary session information to standby device 106.

Step 406 sends a signal to standby device 106 indicating that active device 104 is finished with sending the session information for the sessions considered to be of a higher priority. Active device 104 then waits for an indication that standby device 106 has brought up the sessions.

Step 408 receives the notification that the sessions have been brought up and standby device 106 is marked as ready to take over any of the sessions. Thus, at this point, standby device 106 may be able to take over handling of these sessions in case of an active device failure.

Step 410 then determines a second portion of sessions. These sessions may be a portion of the remaining sessions that are considered of lesser importance. They may be sent right after the first portion or after standby device 106 is marked as ready.

Step 412 then sends session information for the second portion. Active device 104 then waits for an indication from standby device 106 that these sessions have been synced and brought up. Standby device 106 may bring the sessions up in the background.

Step 414 receives notification that the remaining sessions have been brought up. The bulk sync may then end.

Particular embodiments provide many advantages. For example, in the case of an active device 104 failure before finishing a complete bulk sync, particular embodiments provide better service for sessions that are considered a higher priority. For example, losing a session that is considered dormant is a lot less serious than losing a session that is exchanging active traffic. Also, premium users are synced as being a higher priority than general users and thus users from these sessions are provided with better service. For example, a user experience may be considered better if higher priority sessions are synced first. Thus, revenue and/or customer service may be better maintained for a service provider using particular embodiments.

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method comprising:
determining one or more attributes for a plurality of sessions that need to be synced between an active device and a standby device;
determining a priority for syncing sessions in the plurality of sessions based on the one or more attributes for the plurality of sessions; and
syncing sessions in the plurality of sessions with the standby device based on the priority.

2. The method of claim 1, wherein syncing sessions comprising:
determining a first portion of the plurality of sessions to sync;
syncing the first portion of the sessions; and
receiving an indication from the standby device that the first portion of sessions have been brought up, wherein the first portion of sessions is brought up on the standby device while a second portion of sessions has not been synced.

3. The method of claim 2, wherein the indication indicates that the standby device is ready to take over the first portion of sessions if needed and is available to service sessions.

4. The method of claim 2, further comprising:
determining a second portion of the plurality of sessions to sync;
syncing the second portion of the sessions; and
receiving a second indication from the standby device that the second portion of sessions has been brought up.

5. The method of claim 2, further comprising sending a finished indication that the first portion of sessions has been sent and should be brought up by the standby device.

6. A method comprising:
receiving, at a standby device, syncing information for a first portion of sessions in a plurality of sessions from an active device in a syncing process between the active device and the standby device, wherein the one or more attributes for the plurality of sessions are used to determine a priority for syncing sessions;
bringing up the first portion of sessions in the plurality of sessions; and
sending an indication to the active device that the first portion of sessions have been brought up.

7. The method of claim 6, wherein the indication indicates that the standby device is ready to take over the first portion of sessions if needed and is available to act as a standby for active device in servicing the first portion of sessions.

8. The method of claim 6, wherein the first portion of sessions is brought up before a second portion of sessions in the plurality of sessions are synced.

9. The method of claim 6, further comprising:
receiving, at the standby device, second syncing information for a second portion of sessions in the plurality of sessions from the active device in the syncing process between the active device and the standby device;
bringing up the second portion of sessions in the plurality of sessions in a background while being ready to become active for the first portion of sessions; and
sending a second indication to the active device that the second portion of sessions has been brought up.

10. An apparatus comprising:
an attribute determiner configured to determine one or more attributes for a plurality of sessions that need to be synced between an active device and a standby device;
a priority determiner configured to determine a priority for syncing sessions in the plurality of sessions based on the one or more attributes for the plurality of sessions; and
a session information sender configured to sync sessions in the plurality of sessions with the standby device based on the priority.

11. The apparatus of claim 10, wherein the session information sender is further configured to:
determine a first portion of the plurality of sessions to sync;
sync the first portion of the sessions; and
receive an indication from the standby device that the first portion of sessions have been brought up, wherein the first portion of sessions is brought up on the standby device while a second portion of sessions has not been synced.

12. The apparatus of claim 10, wherein the indication indicates that the standby device is ready to take over the first portion of sessions if needed and is available to service sessions.

13. The apparatus of claim 12, wherein the session information sender is further configured to:
determine a second portion of the plurality of sessions to sync;
sync the second portion of the sessions; and
receive a second indication from the standby device that the second portion of sessions has been brought up.

14. The apparatus of claim 12, wherein the session information sender is further configured to send a finished indication that the first portion of sessions has been sent and should be brought up by the standby device.

15. An apparatus comprising:
a sync information receiver configured to receive syncing information for a first portion of sessions in a plurality of sessions from an active device in a syncing process between the active device and the standby device, wherein the one or more attributes for the plurality of sessions are used to determine a priority for syncing sessions;
a session syncer configured to bring up the first portion of sessions in the plurality of sessions; and
a sync conformer configured to send an indication to the active device that the first portion of sessions has been brought up.

16. The apparatus of claim 15, wherein the indication indicates that the standby device is ready to take over the first portion of sessions if needed and is available to act as a standby for active device in servicing the first portion of sessions.

17. The apparatus of claim 15, wherein the first portion of sessions is brought up before a second portion of sessions in the plurality of sessions is synced.

18. The apparatus of claim 15, wherein:
the sync information receiver configured to receive second syncing information for a second portion of sessions in the plurality of sessions from the active device in the syncing process between the active device and the standby device;
the session syncer is configured to bring up the second portion of sessions in the plurality of sessions in a background while being ready to become active for the first portion of sessions; and
the sync conformer is configured to send a second indication to the active device that the second portion of sessions has been brought up.

19. An apparatus comprising:
means for determining one or more attributes for a plurality of sessions that need to be synced between an active device and a standby device;
means for determining a priority for syncing sessions in the plurality of sessions based on the one or more attributes for the plurality of sessions; and
means for syncing sessions in the plurality of sessions with the standby device based on the priority.

20. An apparatus comprising:
means for receiving, at a standby device, syncing information for a first portion of sessions in a plurality of sessions from an active device in a syncing process between the active device and the standby device, wherein the one or more attributes for the plurality of sessions are used to determine a priority for syncing sessions;
means for bringing up the first portion of sessions in the plurality of sessions; and
means for sending an indication to the active device that the first portion of sessions have been brought up.
